(19) United States
(12) Patent Application Publication
(10) Pub. No.: US 2007/0085008 A1
(43) Pub. Date: Apr. 19, 2007

(54) Ceramic corona discharge emitter tip

(75) Inventor: Jeffrey M. Salisbury, Lakeville, MN (US)

Correspondence Address: Fellers, Snider, Blankenship, Bailey & Tippens, Suite 1700, 100 North Broadway, Oklahoma City, OK, 73102-8820, US

(73) Assignee: Seagate Technology LLC, Scotts Valley, CA (US)

(21) Appl. No.: 11/250,645

(22) Filed: Oct. 13, 2005

(51) Int. Cl. H01T 19/04

(52) U.S. Cl. 250/324

(57) ABSTRACT

A corona discharge emitter tip device comprising an electrically conductive ceramic material. A method for controlling electrostatic charge comprising: providing a voltage source; providing the emitter tip comprising an electrically conductive ceramic material; connecting the voltage source to the emitter tip; and electrically energizing the emitter tip. A corona discharge device comprising a voltage source connectable to the emitter tip, and an arrangement for preparing a work piece for manufacturing by steps for controlling the electrostatic charge of the work piece.

### FIELD OF THE INVENTION

The embodiments of the present invention relate generally to the field of electrostatic charge control and more particularly without limitation to corona discharge emitter tips.

### BACKGROUND

Corona discharge ionizer devices are commonly used for controlling the presence of electrostatic charge in manufacturing environments involving sensitive components, such as in the semiconductor and data storage device industries. Corona discharge ionizers employ a number of emitter tips that, when energized with a sufficiently high voltage, create a corona discharge. The corona discharge is an ion cloud having a charge established by the polarity of the voltage. In many cases a non-hydrogen fluid stream is passed over the emitter tips in order to direct and advance the ion stream in order to statically charge or discharge a work piece. However, problems exist in the current state and use of corona discharge ionizers.

One problem is the tendency for precipitating ammonium nitrate on the emitter tip. In order for the tip to effectively create the corona discharge, the emitter tip must remain clean, sharp, and electrically conductive. Such a buildup reduces the tip's effectiveness in creating the corona discharge. Regularly scheduling maintenance activities to clean or replace the emitter tips can be a costly and unworkable production interruption. For purposes of the present description and the meaning of the appended claims, the term “electrically conductive” will broadly mean that the emitter tip can operate either in the conductive or dissipative ranges, depending on its inherent resistance characteristic.

Another problem is associated with bursts of submicron particles coming from the emitter tips that can be introduced into the manufacturing environment. In some cases the contamination comes from sputtering of the material from which the emitter tip is manufactured; in other cases the contamination is particles of the ammonium nitrate precipitation.

While various approaches have been proposed in the art to address the contamination that can be introduced into the manufacturing process by emitter tips, there nevertheless remains a continued need for improvements in the art. It is to such improvements that the claimed invention is directed.

### SUMMARY OF THE INVENTION

In accordance with preferred embodiments, an apparatus and associated method for using an electrically conductive ceramic emitter tip for producing a corona discharge of ionized particles is contemplated.

In some embodiments a corona discharge emitter tip device is provided comprising an electrically conductive ceramic material. Preferably, the emitter tip comprises zirconia-doped ceramic material.

In other embodiments a method for controlling electrostatic charge is provided comprising: providing a voltage source; providing the corona discharge emitter tip comprising an electrically conductive ceramic material; connecting the voltage source to the emitter tip; and electrically energizing the emitter tip.

In other embodiments a corona discharge device is provided comprising a voltage source connectable to the emitter tip, and an arrangement for preparing a work piece for manufacturing by steps for controlling the electrostatic charge of the work piece.

These and various other features and advantages which characterize the claimed invention will become apparent upon reading the following detailed description and upon reviewing the associated drawings.

### BRIEF DESCRIPTION OF THE DRAWINGS FIG. 1 is a diagrammatic illustration of a corona discharge device constructed in accordance with embodiments of the present invention.

FIG. 2 is a side elevational view of the emitter tip of the device of FIG. 1.

FIG. 3 is a front elevational view of the emitter tip of the device of FIG. 1.

FIG. 4 is a flowchart of a method for CONTROLLING ELECTROSTATIC CHARGE illustrating steps for practicing the embodiments of the present invention.

FIG. 5 is a diagrammatic illustration of a corona discharge device constructed in accordance with alternative embodiments of the present invention.

### DETAILED DESCRIPTION

FIG. 1 is a diagrammatic illustration of a corona discharge device 100 constructed in accordance with embodiments of the present invention. The device 100 comprises an emitter tip 102 that is electrically connectable to a high voltage source 104. The illustrative embodiments of FIG. 1 identify the voltage source 104 as being an alternating current type voltage source. In equivalent alternative embodiments the voltage source 104 can be a direct current voltage source, and preferably can be a pulsed or direct current steady state voltage source. The voltage source 104 electrically energizes the tip 102 which, by way of its construction, emits a corona discharge 106 of electrically charged ions.

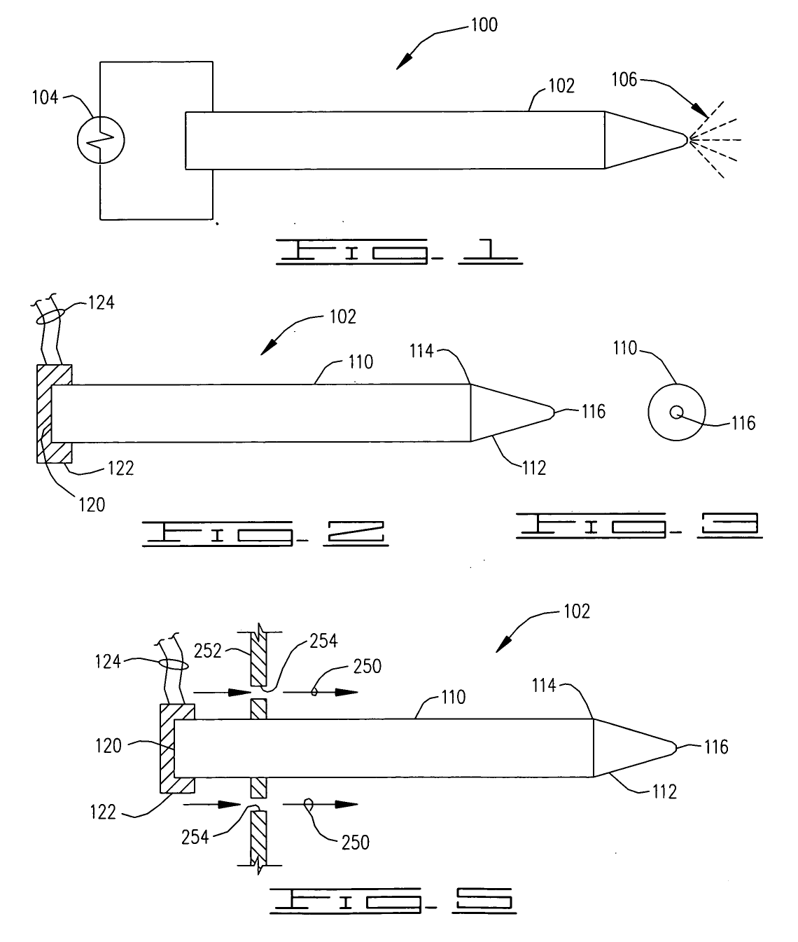

FIGS. 2 and 3 are side and end elevational views of the emitter tip 102, which generally comprises an elongated body 110 with a tapered end 112. In the illustrative embodiments herein, the body 110 defines a circular cross section with a diameter of about 0.100 inches. The tapered end 1 12 is substantially contiguous with the body 110 at a proximal end 114 thereof, and terminates in a sharp or radiused tip portion at a distal end 116. In preferred embodiments the distal end 116 defines about a 0.003 inch radius. In the circular cross section embodiments of FIG. 2 the tapered end 112 is conical.

A connecting end 120 of the body 110, opposite the tapered end 112, is configured for electrically engaging a socket 122 which is, in turn, electrically connected to the high voltage source 104 (FIG. 1) by leads 124. In some embodiments illustrated in FIG. 1 the voltage source 104 provides a voltage in the range of about 2,000 to 15,000 volts.

The emitter tip 102 comprises an electrically conductive ceramic material in order to prevent contamination of the manufacturing environment by sputtering of the emitter tip material. Preferably, the emitter tip 102 comprises a zirconia-doped ceramic material, which does not outgas under operable conditions. Such an emitter tip 102 can be manufactured from a material marketed under the name Cerastat™ from Saint-Gobain Advanced Ceramics of Niagara Falls, N.Y.

As seen below, the embodiments of the present invention contemplate operating within a resistance range that encompasses both the conductive and dissipative ranges, which transition occurs at about 1 megohm. The desired resistance is generally inversely proportional to the amount of additive doped to the ceramic material, whether it is zirconia or other additives such as but not limited to boron or nickel.

In the embodiments represented by FIG. 2, it will be noted that the emitter tip 102 taking the form of a cylindrical elongated body 110 with a conical radiused tapered end 112 can provide a characteristic electrical resistance of less than 100 megohms.

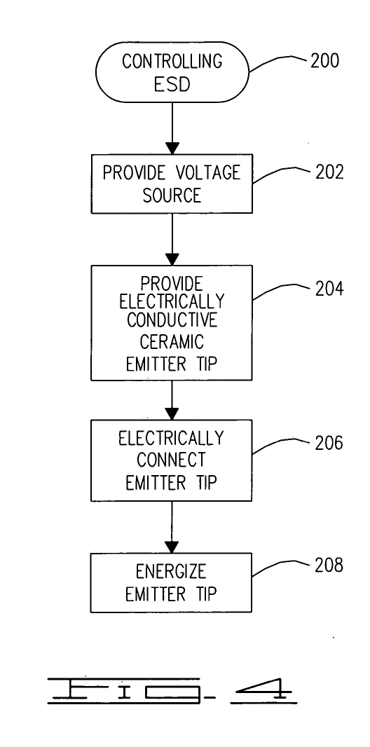

FIG. 4 is a block diagram of a method 200 for CONTROLLING ELECTROSTATIC CHARGE illustrating steps for carrying out the embodiments of the present invention. The method 200 includes providing the voltage source 104 (FIG. 1) in block 202. In step 204 the electrically conductive ceramic emitter tip 102 (FIG. 2) is provided. In step 206 the voltage source 104 (FIG. 1) is connected to the emitter tip 102 (FIG. 2). In step 208 the emitter tip 102 (FIG. 2) is electrically energized to produce the ionized particle stream 106 (FIG. 1).

In some embodiments the providing a corona discharge emitter tip comprises forming the emitter tip 102 from a zirconia-doped ceramic material. The providing a corona discharge emitter tip step can further comprise, as shown in FIG. 2, forming the emitter tip 102 as comprising the elongated body 110 with the tapered end 112. In some embodiments the providing a corona discharge emitter tip 102 further comprises forming the body 110 with an outer surface defining a characteristic cross sectional configuration, and forming the tapered end 112 at a proximal end thereof as being substantially contiguous with the outer surface, and terminating the tapered end 112 at a distal end thereof 116 as a sharp or radiused point. FIGS. 2 and 3 particularly illustrate embodiments wherein the providing a corona discharge emitter tip 102 comprises forming the outer surface as being circular in cross section and the tapered end 112 as being conical. In this arrangement, embodiments can provide a corona discharge emitter tip comprising a characteristic electrical resistance of less than 100 megohms.

The embodiments of FIG. 1 generally contemplate a corona discharge device comprising a voltage source connectable to an emitter tip, and an arrangement for preparing a work piece for manufacturing by steps for controlling the electrostatic charge of the work piece. As described in the method 200, the steps for controlling contemplate providing an emitter tip 102 formed of an electrically conductive ceramic material, and connecting the emitter tip 102 to the voltage source. In some embodiments the steps for controlling is characterized by providing the emitter tip 102 comprising zirconia-doped ceramic material. In the configuration described above, the steps for controlling are characterized by providing an emitter tip 102 comprising a characteristic electrical resistance of less than 100 megohms.

In some embodiments the steps for controlling is characterized by machining pin stock of the electrically conductive ceramic material into the desired emitter tip configuration. In other embodiments, the steps for controlling is characterized by molding the material into a desired emitter tip configuration, and the steps for controlling can further be characterized by sintering the molded material.

FIG. 5 is a side elevational view of the emitter tip 102 utilized in accordance with alternative embodiments of the corona discharge device of FIG. 1. Here, a fluid flow 250 is provided in order to advance the ionized particles toward a work piece (not shown). The fluid flow 250 can be directed around the emitter tip 102 by a dielectric partition 252 that defines one or more openings 254 for passing the fluid flow 250.

Summarizing generally, an emitter tip (such as 102) is provided for a corona discharge device (such as 100). The emitter tip comprises an elongated body (such as 110) with a tapered end (such as 112).

The body defines a characteristic size, and the tapered end is substantially contiguous with the body at a proximal end (such as 114) thereof, and terminates in a sharp or radiused tip portion at a distal end (such as 116) thereof. In some embodiments the body is circular and the tapered end is conical.

The emitter tip device comprising an electrically conductive ceramic material, such as but not limited to zirconia-doped ceramic material. Such a material in such a configuration is capable of producing an emitter tip comprising a characteristic electrical resistance of less than 100 megohms.

In some embodiments a method (such as 200) is provided for controlling electrostatic charge comprising: providing a voltage source (such as 202); providing the corona discharge emitter tip comprising an electrically conductive ceramic material (such as 204); connecting the voltage source to the emitter tip (such as 206); and electrically energizing the emitter tip (such as 208).

The providing the corona discharge emitter tip can comprise forming the emitter tip as comprising an elongated body with a tapered end. The providing the corona discharge emitter tip can further comprise forming the body with an outer surface defining a characteristic cross sectional configuration, and forming the tapered end at a proximal end thereof as being substantially contiguous with the outer surface, and terminating the tapered end at a distal end thereof as a sharp or radiused tip portion. In some embodiments the providing the corona discharge emitter tip comprises forming the outer surface as being circular in cross section and the tapered end as being conical. In embodiments illustrated by this configuration, the providing the corona discharge emitter tip can comprise forming the emitter tip from a zirconia-doped ceramic material, making it possible to provide the emitter tip with a characteristic electrical resistance of less than 100 megohms.

In other embodiments a corona discharge device is contemplated comprising a voltage source connectable to an emitter tip, and an arrangement for preparing a work piece for manufacturing by steps for controlling the electrostatic charge of the work piece.

The steps for controlling is characterized by providing an emitter tip comprising an electrically conductive ceramic material, and connecting the voltage source to the emitter tip. The steps for controlling can be characterized by providing the emitter tip comprising zirconia-doped ceramic material. In this configuration the steps for controlling can be characterized by providing the emitter tip comprising a characteristic electrical resistance of less than 100 megohms.

The steps for controlling can be characterized by machining pin stock of the electrically conductive ceramic material into the desired emitter tip configuration; alternatively, the steps for controlling can be characterized by molding the material into a desired emitter tip configuration, and if necessary by sintering the molded material.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular configuration and arrangement of the emitter tip body and tapered end portions without departing from the spirit and scope of the present invention.

What is claimed is:

1. A device for controlling an electrostatic charge with a corona discharge emitter tip comprising an electrically conductive ceramic material.

2. The device of claim 1 wherein the tip comprises zirconia-doped ceramic material.

3. The device of claim 1 wherein the tip comprises a characteristic electrical resistance of less than 100 megohms.

4. The device of claim 1 wherein the tip comprises an elongated body and a tapered end.

5. The device of claim 4 wherein the body is cylindrical and the tapered end is conical.

6. The device of claim 4 wherein the tapered end terminates in a tip portion at a distal end.

7. A method for controlling electrostatic charge comprising:
providing a voltage source;
providing a corona discharge emitter tip comprising an electrically conductive ceramic material;
connecting the voltage source to the emitter tip; and
electrically energizing the emitter tip.

8. The method of claim 7 wherein the providing a corona discharge emitter tip comprises forming the emitter tip as comprising an elongated body with a tapered end.

9. The method of claim 8 wherein the providing a corona discharge emitter tip comprises forming the body with an outer surface defining a characteristic cross sectional configuration, and forming the tapered end at a proximal end thereof as being substantially contiguous with the outer surface, and terminating the tapered end at a distal end thereof as a tip portion.

10. The method of claim 9 wherein the providing a corona discharge emitter tip comprises forming the outer surface as being circular in cross section and the tapered end as being conical.

11. The method of claim 7 wherein the providing a corona discharge emitter tip comprises forming the emitter tip from a zirconia-doped ceramic material.

12. The method of claim 7 wherein the providing a corona discharge emitter tip comprises forming the emitter tip to comprise a characteristic electrical resistance of less than 100 megohms.

13. A corona discharge device comprising:
a voltage source; and
an arrangement for preparing a work piece for manufacturing by steps for controlling the electrostatic charge of the work piece.

14. The device of claim 13 wherein the steps for controlling is characterized by connecting the voltage source to the emitter tip.

15. The device of claim 13 wherein the steps for controlling is characterized by providing an emitter tip comprising an electrically conductive ceramic material.

16. The device of claim 15 wherein the steps for controlling is characterized by providing an emitter tip comprising zirconia-doped ceramic material.

17. The device of claim 15 wherein the steps for controlling is characterized by providing an emitter tip comprising a characteristic electrical resistance of less than 100 megohms ohms.

18. The device of claim 16 wherein the steps for controlling is characterized by machining pin stock into a desired emitter tip configuration.

19. The device of claim 16 wherein the steps for controlling is characterized by molding the material into a desired emitter tip configuration.

20. The device of claim 19 wherein the steps for controlling is characterized by sintering the molded material.
